(19) United States
(12) Patent Application Publication
(10) Pub. No.: US 2016/0276688 A1
(43) Pub. Date: Sep. 22, 2016

(54) ION-EXCHANGE MEMBRANE WITH PREFERENTIALLY ORIENTED MORPHOLOGICAL TEXTURE

(71) Applicant: NATIONAL CENTRAL UNIVERSITY, Taoyuan City (TW)

(72) Inventors: Po-Jen Chu, Taoyuan City (TW); Yu-Cheng Tseng, Taoyuan City (TW)

(73) Assignee: NATIONAL CENTRAL UNIVERSITY, Taoyuan City (TW)

(21) Appl. No.: 14/874,045

(22) Filed: Oct. 2, 2015

(30) Foreign Application Priority Data
Mar. 17, 2015 (TW) 104108425

(51) Int. Cl. H01M 8/10

(52) U.S. Cl. CPC H01M 8/1055; H01M 8/1039; H01M 8/1025; H01M 8/1032; H01M 2300/0071; H01M 2300/0082

(57) ABSTRACT

An ion-exchange membrane with a preferentially oriented morphological texture is provided. The ion-exchange membrane includes a polymeric substrate; and nanoparticles embedded in the polymeric substrate. The relative amount of the nanoparticles is from 0.1 to 5 wt %, based on the total weight of the ion-exchange membrane, and the value of ion agglomeration is less than 3.4 nm. The ion-exchange membrane of the present invention shows superior ion-conducting behavior.

### CROSS-REFERENCE TO RELATED APPLICATION

This application claims foreign priority under 35 U.S.C. §119(a) to patent application Ser. No. 104108425, filed on Mar. 17, 2015, in the Intellectual Property Office of Ministry of Economic Affairs, Republic of China (Taiwan, R.O.C.), the entire content of the above-referenced application is incorporated herein by reference.

### BACKGROUND OF THE INVENTION

1. Field of the Invention

The present invention relates to ion-exchange membranes, and more specifically, to a composite membrane for ion exchange purpose employed in renewable energy devices.

2. Description of Related Art

One of the functions of an ion-exchange membrane in a fuel cell is to transfer protons to complete electric circuit. Thus, the quality of a fuel cell depends heavily on the property and efficiency of an ion-exchange membrane. Currently, active research is devoted to improve proton conductivity and lengthen lifespan of membrane.

Besides the function of transferring protons, an ion-exchange membrane also served the function of isolation e in a renewable energy devices. This include isolating an anode and a cathode in a cell to avoid a short circuit, and isolating fuels; for example, methanol or gas fuel (e.g., hydrogen) in the cell, to prevent cross-over of those fuels from contacting the opposite electrode through the membrane. An effective blockage can avoid the mixing of potential, such that high energy efficiency of the renewable energy device can be realized. In addition to the high proton conductivity, mechanical strength, membrane-forming ability are also required of an ion-exchange membrane material.

However, this is a challenging task to balance high proton conductivity and low methanol cross-over while maintain high chemical, mechanical and thermal stabilities. Currently, most of ion-exchange membranes are thin films made from, for example, perfluorinated sulfonic acid resin Nafion®. Although such membrane has high proton conductivity, its high level of swelling in a methanol solvent can cause serious methanol cross-over during cell operation and result in the decrease of the fuel cell efficiency.

Other materials for the ion-exchange membrane, such as hydrophilic sulfonated polyether ether ketone (sPEEK), shows good proton conductivity, and its lifespan can be up to 3000 hours during the fuel cell operation. The production of such membrane is also easy, for example, by using commercially available polyether ether ketone (PEEK). Sulfonated polyether ether ketone (sPEEK) having different levels of sulfonation can be prepared by controlling time and temperature of contact with sulfuric acid. In general, sPEEK with higher degree of sulfonation delivers higher the proton conductivity. However, tests of water uptake and methanol uptake show that, as the degree of sulfonation of sPEEK exceeds 70%, the ion-exchange membrane shows huge amount of water uptake and swells seriously in methanol to the point of disintegration and dissolution in the solvent. On account of neither having high proton conductivity and high mechanical strength at the same time, nor avoiding swelling in methanol, the sPEEK membranes cannot be well applied to the fuel cells.

In order to reduce the methanol cross-over, various approaches are taken to modify an ion-exchange membrane, for example, by mixing other polymeric materials with a polymeric substrate, or forming a composite polymeric ion-exchange membrane by using inorganic nanoparticles and an organic polymeric substrate. However, those modifications aimed to avoid or to reduce methanol cross-over usually cause side effects including lowering proton conductivity. Requirements of high conductivity and low methanol swelling cannot be met at the same, based on conventional approaches. New approaches to produce a proton conducting membrane exhibiting both high conductivity low swelling and low methanol cross-over is an urgent issue which could boost of the progress of fuel cell industry.

Another important progress in fuel cells is to operate it in higher temperatures. Advantages of an operating fuel cell at a temperature higher than 120° C. are as follows: (1) reduction of CO poisoning; (2) raise of the reaction rate and electric power of the cell; (3) reduction in problems of thermal and water management; and (4) reduction in production cost. However, under thermal condition, water molecules, which are conventionally used to transfer proton in a fuel cell, evaporates easily, and the conductivity deteriorated rapidly. Thus, many of the aforesaid advantages of operating in a high temperature can not be realized. In short, ion-exchange membranes suitable to operate at elevated temperature condition must be able to retain sufficient water molecules, even at a temperature higher than 120° C., to help proton conduction.

Currently, numerous research have been conducted on organic/inorganic nano-structured composite membrane and applied to the fuel cell. For example, a known technique in the art uses a sPEEK polymer as main substrate for blending with nano-structured inorganics to form a nano-structured composite membrane, wherein the nano-structured inorganics comprises a MCM-41 molecular sieve with a hexagonally ordered pore structure, silicon dioxide, aluminum oxide, titanium dioxide, and zirconium dioxide. The aforesaid nano-structured complex system is often presented as multiple structures, and thereby producing new property. While adding higher weight percentages (>10 wt %) of nanoparticles, the membrane shows lower conductivity than the one without modification; but with reduce to proper weight percentage of particles, the membrane shows optimized conductivity.

Furthermore, operating a fuel cell with a hydrogen-oxygen ion-exchange membrane at a high temperature (higher than 120° C.) using the composite membrane prepared by a perfluorinated sulfonic acid resin and nano-structured metal oxide shows good cell efficiency. For example, U.S. Pat. No. 7,022,427 discloses a composite membrane, wherein a colloidal perfluorinated sulfonic acid resin containing metal alkoxide is used by depositing or bonding to a polymer to form a membrane with thickness of about 5 to 30 microns (μm).

In addition, other related researches regarding the use of organic/inorganic composite nano-structured membranes to the fuel cells also yield fair results. For example, U.S. Pat. No. 7,022,810 discloses that an ion-exchange membrane produced by adding inorganic silicon dioxide into an alternating copolymer of sulfonated polyimide. In addition to display a lower level of swelling, higher thermal stability, and reduced crossover of oxygen-hydrogen fuel, the ion-exchange membrane has a conductivity of 5×10⁻² S/cm, which is close to that of the perfluorinated sulfonic acid resin. Further, Taiwanese Pat. No. I3818810 discloses a nano-structured composite ion-exchange membrane, wherein the surfaces of nanoparticles are each modified by a functional group, and then forms an organic/inorganic composite ion-exchange membrane having a conductivity of 2.6×10⁻² S/cm with an acidic electrolyte polymer.

Although a conventional technique in the art is already demonstrated by blending nanoparticles with a polymeric substrate to effectively reduce water and methanol crossover and inhibit the membrane to overly swell, the conductivity of the membrane is also inhibited at the same time. Furthermore, the inability to homogeneously disperse the inorganic nanoparticles in the organic polymer is a serious issue, as it may cause phase separation and affect the efficiency of the fuel cell. The aforesaid composite membranes formed by blending the nanoparticles, each having a functionalized surface with a polymer, still fails to achieve equilibrium at a wide range of operating temperatures (from 0 to 140° C.), reduce cross-over of water and methanol, or improve the proton conductivity at the same time.

The aforesaid problems restrict further development and applications of the fuel cell. Accordingly, the problems of the lower performance of the fuel cell, due to the aforesaid ion-exchange membrane not having higher conductivity, mechanical strength, and low methanol crossover all at the same, or unevenly distribution of the inorganic particles in the polymeric substrate, are urgent technical problems need to be resolved. However, there is still lacking a perfect solution to date.

The present invention is designed to solve these aforesaid issues in fuel cells by tailoring or modifying the morphological texture suitable for ion transport within ion-exchange membrane. The ion-exchange membrane of the present invention is characterized by heterogeneous morphological texture and shows an anistropic conductive property (much larger conductivity in the through plane direction than in the perpendicular direction) and superior ion conduction along the direction of a vertically cross-sectional plane. The ion exchange membrane prepared based on the method disclosed in this invention can meet the requirements of low water loss, low methanol cross-over, and exhibited high mechanical strength at the same time.

### SUMMARY OF THE INVENTION

The present invention disclosed an ion-exchange membrane with a preferentially oriented morphological texture, including a polymeric substrate; and nanoparticles embedded in the polymeric substrate. The amount of the nanoparticles is from 0.1 to 5 wt %, based on the total weight of the ion-exchange membrane, and the value of the ion agglomeration of the ion-exchange membrane is measured to be less than 3.4 nm.

In one embodiment, the polymeric substrate is at least one selected from the group consisting of polyether ether ketone (PEEK), perfluorinated sulfonic acid resin (Nafion), poly(imide) (PI), polysulfone, poly(vinylphosphonic acid) (PVPA), and poly(acrylic acid) (PAA).

In one embodiment, the polymeric substrate can be further modified by sulfonate (SO₃⁻), phosphite (PO₃²⁻), or carboxylate (COO⁻).

In one embodiment, the nanoparticles are inorganic nanoparticles, and can be at least one selected from the group consisting of titanium dioxide (TiO₂), silicon dioxide (SiO₂), aluminum oxide (Al₂O₃), zirconium dioxide (ZrO₂), and a carbon nanotube.

In yet one embodiment, in addition to preparing the nanoparticles according to the amounts and materials described in the present invention, the nanoparticles can further be modified by sulfonate (SO₃⁻), phosphite (PO₃²⁻), or carboxylate (COO⁻).

In one embodiment, the nanoparticles each has a cylindrical shape and a length-to-diameter ratio of greater than 1. In the present invention, the term “cylinder” refers to the one with the shape of a cylinder, a tuber or a strip. Additionally, in one embodiment, the length-to-diameter ratio of the nanoparticles is about 2 to 100.

According to the ion-exchange membrane having preferentially oriented morphological texture disclosed in the present invention, the nanoparticle is modified by the functional groups to enhance the compatibility with the organic polymeric substrate. After surface functionalization, the inorganic nanoparticles can distribute more evenly in the polymer to avoid the problem of phase separation. Upon the application of electric field, the inorganic nanoparticles are polarized and induced by the electric field to form aligned arrangement in the organic polymeric substrate. This produces heterogeneous, continuous, and preferentially ordered nano-structure forming an extremely efficient proton transfer path. As a result of the preferentially ordered nanostructure, the proton transfer efficiency is greatly enhanced. The averaged channel (and pore) size of the composite membrane of the present invention is identified to be smaller than that of perfluorinated sulfonic acid resin, widely used in common fuel cell technology. The ion-exchange membrane provided by the present invention can maintain a lower level of water absorption; and exhibits a low level of swelling. Additionally, when operating at a high temperature, the membrane is favorable to reduce water loss, such that good proton conductivity is maintained and thereby effectively reducing methanol cross-over. Furthermore, the ion-exchange membrane of the present invention also displayed enhanced mechanical strength able to resist a higher level of elongation.

### BRIEF DESCRIPTION OF THE DRAWINGS

FIG. 1A shows infrared spectrums of zirconium dioxide (top panel) and titanium dioxide (bottom panel) nanoparticles modified by sulfonation, respectively; FIGS. 1B-1E are FE-SEM images of the inorganic particles of the present invention by using a scanning electronic microscope (SEM), wherein FIGS. 1B-1E are zirconium dioxide, sulfonated zirconium dioxide, titanium dioxide, and sulfonated titanium dioxide, respectively;

FIG. 2 shows a comparison of the water contents, levels of swelling, and proton conductivity of the membranes, wherein bars filled with diagonal lines indicate the water contents, colored bars indicate swelling degrees, and polygonal curve indicates the proton conductivity;

FIG. 3 shows the results of an elongation test to determine the mechanical strength of the membranes, wherein N117 is a commercially available Nafion product;

FIGS. 4A-4F show cross-sectional SEM images of the composite membranes, wherein FIGS. 4A-4F respectively indicate pure Nafion (re-Nafion), a Nafion membrane with added sulfonated zirconium dioxide nanoparticles (sZrO₂/N), a Nafion membrane with added titanium dioxide nanoparticles (sTiO₂/N), a pure Nafion membrane induced by an electric field (Nafion/DE), a Nafion membrane with added sulfonated zirconium dioxide nanoparticles induced by an electric field (sZrO₂/N/DE), and a Nafion membrane with added sulfonated titanium dioxide nanoparticles induced by an electric field (sTiO₂/N/DE);

FIG. 5A shows a comparison of the water contents, levels of swelling, and proton conductivity of the pure Nafion membrane and sZrO₂/N membranes both induced by electric fields with different strengths, wherein bars filled with diagonal lines indicate the water contents, colored bars indicate swelling degrees, and polygonal curve indicates the proton conductivity; FIG. 5B shows a comparison of the water contents, levels of swelling, and proton conductivity of the pure Nafion membrane and sTiO₂/N membrane induce by an electric field, wherein bars filled with diagonal lines indicate the water contents, colored bars indicate swelling degrees, and polygonal curve indicates the proton conductivity; and FIG. 5C shows a comparison of the proton conductivity of sTiO₂/sPEEK composite membranes before and after being induced by an electric field at different temperatures (from 30 to 80° C.) and a constant relative humidity of less than 100%;

FIG. 6 shows the results of an elongation test to determine the mechanical strength of the membranes, wherein N117 is a commercially available Nafion product;

FIG. 7A shows the results of a test for proton conductivity at varying relative humidity conditions and a constant temperature of 80° C.; and FIG. 7B shows the results of a test for proton conductivity at varying temperatures and a constant relative humidity of 100%;

FIG. 8A shows a set of distributional diagrams of the diffusion rates of water molecules as measured by solid-state nuclear magnetic resonance; and FIG. 8B show a set of distributional diagram of the diffusion tensor directions of water molecules as measured by solid-state nuclear magnetic resonance, wherein three spatial angles of the tensor are positioned by Euler angles, α, β, γ, and the more concentrated the distribution of the angle is, the stronger the preferential orientation is;

FIG. 9 shows the results of tests of methanol cross-over and proton conductivity of the membranes in presence of methanol, wherein bars filled with diagonal lines indicate the water contents, and polygonal curve indicates the proton conductivity;

FIG. 10 shows the results of a single cell efficiency test on a direct methanol fuel cell using the membranes at a temperature of 80° C. and a relative humidity of 60%; and

FIG. 11A and FIG. 11B show the results of an efficiency test on a single hydrogen-oxygen fuel cell using the ion-exchange membrane of the present invention and a commercially available N212 ion-exchange membrane at temperatures of 60° C. and 70° C. and relative humidity of from 30 to 80%, respectively.

### DETAILED DESCRIPTION OF THE PREFERRED EMBODIMENTS

The present invention disclosed a method to prepare ion-exchange membrane with a preferentially oriented morphological texture, including a polymeric substrate; and nanoparticles embedded in the polymeric substrate, wherein the amount of the nanoparticles is from 0.1 to 5 wt %, based on the total weight of the ion-exchange membrane, and the value of the ion agglomeration of the ion-exchange membrane is less than 3.4 nm.

In an embodiment, the value of the ion agglomeration of the ion-exchange membrane with a preferentially oriented morphological texture is from 3.2 nm to less than 3.4 nm.

The term “preferentially oriented morphological texture” used herein refers to a morphological texture of the material having a specific orientation, i.e., anisotropy. The morphological texture refers to a crystallographic orientation or the orientations of components in a polycrystalline system (containing both crystalline and amorphous structures). If the orientations are arbitrary or random, this kind of sample is referred as not having a morphological texture and the structure thereof is isotropic, i.e., a non-preferential orientation. However, if the crystallographic orientations or structural composition is not random (i.e., preferential orientation), the sample would directly exhibit a weak, moderate, and strong oriented morphological texture. The composition of the sample would be anisotropic. The degree of anisotropy is dependent on the percentage of preferential orientation of the crystallite or composition, and can be confirmed by many optical or spectral methods. For example, the degree of anisotropy depends on the extent of concentration of the distribution of positioned space angles as measured by solid-state nuclear magnetic resonance.

The method of producing an ion-exchange membrane with a preferentially oriented morphological texture of the present invention is firstly to dissolve a polymeric substrate in an suitable solvent, and then to blend inorganic nanoparticles into the polymeric solution, wherein the inorganic nanoparticles are selectively modified by functional groups (depending on the selected polymeric substrate), so as to distribute evenly in the polymeric substrate. Then, the mixture of the aforesaid materials forms a composite membrane. An external electric field is applied during the membrane-forming stage for inducing alignment, so as to obtain a composite membrane having small pores and a preferentially oriented morphological texture.

According to the aforesaid method, the present invention provides an ion-exchange membrane with a preferentially oriented morphological texture, including a polymeric substrate; and inorganic nanoparticles embedded in the polymeric substrate, wherein the amount of the nanoparticles ranged from 0.1 to 5 wt %, based on the total weight of the composite membrane.

Regarding the ion-exchange membrane with a preferentially oriented morphological texture according to the present invention, the polymeric substrate can be one known in the art, preferably polyether ether ketone (PEEK), perfluorinated sulfonic acid resin (Nafion), poly(imide) (PI), polysulfone, poly(vinylphosphonic acid) (PVPA), and poly(acrylic acid) (PAA), and more preferably polyether ether ketone (PEEK) and perfluorinated sulfonic acid resin (Nafion).

Regarding the ion-exchange membrane with a preferentially oriented morphological texture according to the present invention, nanoparticles are inorganic nanoparticles, such as titanium dioxide (TiO₂), silicon dioxide (SiO₂), aluminum oxide (Al₂O₃), zirconium dioxide (ZrO₂), and a carbon nanotube. The inorganic nanoparticles can each be selectively modified by a functional group, such as sulfonate (SO₃⁻), phosphite (PO₃²⁻), or carboxylate (COO⁻), and preferably by sulfonate according to an embodiment of the present invention.

In an embodiment of the present invention, the nanoparticles are preferably inorganic nanoparticles, and can be at least one selected from the group consisting of titanium dioxide (TiO₂), silicon dioxide (SiO₂), aluminum oxide (Al₂O₃), zirconium dioxide (ZrO₂), and a carbon nanotube.

In yet one embodiment, in addition to the nanoparticles prepared by the aforesaid amounts and materials described in the present invention, the nanoparticles can be modified by sulfonate (SO₃⁻), phosphite (PO₃²⁻), or carboxylate (COO⁻), preferably by sulfonate.

In the embodiment of the present invention, the nanoparticles are cylindrical, and have a length-to-diameter ratio of more than 1. In the present invention, the term “cylinder” used herein refers to the shape of a cylinder, tube or strip. Additionally, in one embodiment, the length-to-diameter ratio of the nanoparticles is about 2 to 100.

According to the ion-exchange membrane with a preferentially oriented morphological texture of the present invention, the polymeric substrate used therein is firstly dissolved in a solvent to formulate a 10 wt % of a polymeric substrate solution. The solvent for dissolving the polymeric substrate can be dimethylform amide (DMF), dimethylacetamide (DMAc), N-methyl pyrrolidone (NMP) and dimethyl sulfoxide (DMSO).

The following description illustrates the methods for preparing the compounds used in ion-exchange membranes each with a preferentially oriented morphological texture of the present invention, and illustrates the features of the membrane of the present invention.

Specific embodiments are used to illustrate the methods for implementing the present invention as below. One skilled in the art shall be able to readily conceive the other advantages and effects of the present invention from the content of disclosure of the present specification. The present invention can also be implemented or applied based on different embodiments. Each of the details of the present invention can also be modified and changed, based on different points of view and applications without departing from spirit of the present invention. Description in detail of the present invention is provided in following embodiments with the appended drawings attached, in order to thoroughly conceive the purpose, features and effects of the present invention.

### EXAMPLES

### 1. Methods for Synthesizing a ZrO₂ Nanorod and TiO₂ Nanotube

ZrO₂ Nanorod:

(a) ZrO(NO₃)₂.xH₂O was used to prepare 20 mL of a 0.5 M solution of ZrO(NO₃)₂.xH₂O, After mixing with the same volume of a 5 M of NaOH aqueous solution, 8 mL of absolute ethanol was added therein. The mixture is vibrated by using ultrasonic for 30 minutes.

(b) The resultant solution from step (a) was transferred to a 100 mL Teflon flask before being heated in an autoclave until 200° C. for 72 hours.

(c) After the solution was left to stand until it reached the room temperature, solid white powder is obtained. The obtained powder was washed by deionized water, and then dried at 80° C. in an oven. The obtained product was ZrO₂ nanorod.

Preparation of TiO₂ Nanotube:

(a) 1 g of TiO₂ powder (P25, a diameter of 25 nm) was mixed with 30 mL of a 10 M of NaOH_{(aq)} and then heated in a round-bottom flask to 110° C., and refluxed for 60 hours.

(b) After the resultant mixture from step (a) was left to stand until it reached the room temperature, the pH level is adjusted to 2 by 0.1 M of HCl. Then, it was washed by deionized water to become neutral.

(c) By suction filtration, white power was obtained from the mixture from step (b), and was dried at 80° C. in an oven. The obtained product was TiO₂ nanotube.

### 2. Modification by Sulfonation of the Inorganic Nanoparticle

(a) The aforesaid dried inorganic nanoparticles were added into a 1 M solution of potassium tert-butylate (t-BuOK) in tetrahydrofuran (THF), and the mixture was vibrated by using ultrasonic before being stirred for 12 hours.

(b) 1,3-propane soltone was added into the resultant mixture from step (a), and stirred under N₂ reflux for 24 hours at 60° C.

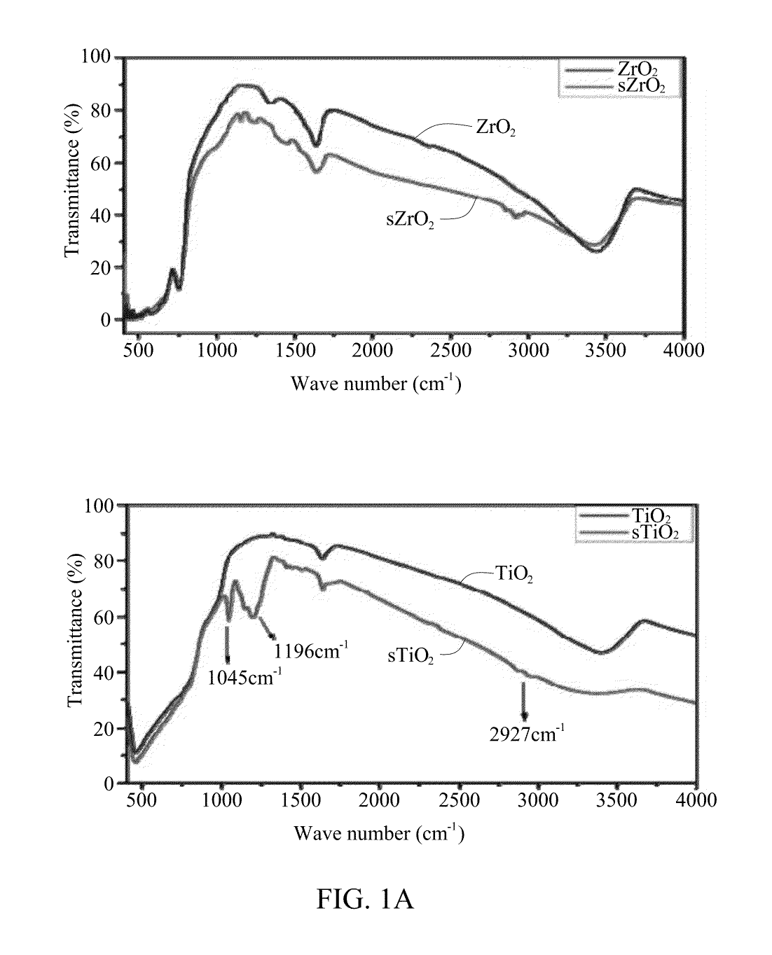

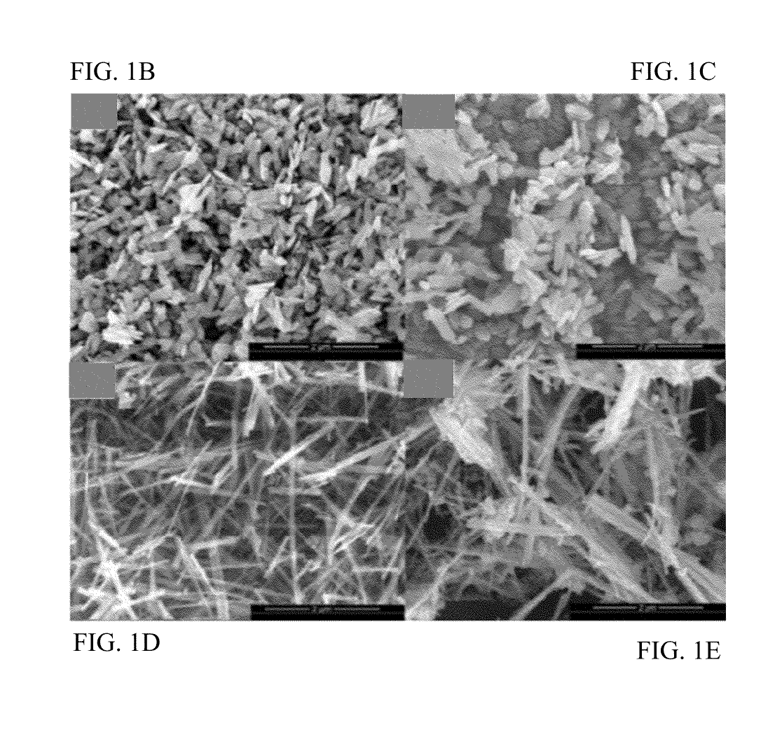

(c) After the resultant mixture from step (b) was suction filtrated, the obtained powder was washed by absolute THF for several times before vacuum drying at 80° C. The nano-structured metal oxide with sulfonate was obtained. FIG. 1A is infrared spectrum of sulfonated nanoparticles, wherein the top panel and the bottom panel respectively refer to sulfonated zirconium dioxide (hereinafter referred to as sZrO₂) and sulfonated titanium dioxide (hereinafter referred to as sTiO₂). It shows in FIG. 1A that that the sulfonated nanotubes have −OH characteristic peaks at 3000 to 3500 cm⁻¹, which are the positions of the characteristic peaks of the —OH groups on the nanotube itself and the sulfonate. Further, a stretching characteristic peak of −CH₂− on a carbon chain is found at 2900 cm⁻¹; and characteristic peaks of symmetric stretching and asymmetric stretching of S═O are found at 1196 and 1045 cm⁻¹. This can corroborate that the nanoparticles prepared according to the method of the present invention are indeed modified by sulfonate.

The size and shape of the sulfonated nanoparticles used in an embodiment of the present invention are shown in FIGS. 1B-1E, by Field Emission Scanning Electronic Microscope (FESEM). It is found that the structure of sZrO₂ has a rod-like structure with an average length and diameter of 480 nm and 80 nm, respectively. Additionally, sTiO₂ has a long tubular shape with an average length and diameter of about 870 nm and 42 nm, respectively. The nanoparticles having surface modified by the functional groups show partial aggregation in dry state. The reason for the phenomenon is that the functional group on the surface of the organic carbon chain change from a hydroxyl group to sulfonate at the terminus. Consequently, the interaction among the surfaces of the inorganic nanoparticles increases, and thereby causing aggregation.

### 3. Preparation of an Ion-Exchange Membrane with a Preferentially Oriented Morphological Texture

Steps for preparing an ion-exchange membrane in one embodiment of the present invention are as follows:

(a) The aforesaid inorganic nanoparticles with sulfonate was dissolved in 1 mL of ethanol, and mixed evenly by ultrasonic vibration. Nafion (Du Pont, USA) polymeric solution was added therein and stirred evenly.

(b) The mixture from step (a) was stirred for 2 hours at 110° C. to volatilize the solution to increase the viscosity thereof.

(c) The mixture from step (b) was coated on a glass slide, and an external electric field was applied to the slide to form a membrane thereon at 110° C. The slide was heated for 2 hours at 140° C.

(d) The obtained membrane from step (c) was acid-washed with 0.5 M sulfuric acid for 2 hours to replace impurities in the membrane by protons, and then washed by deionized water until the pH value of the solution was near neutral. A yellow-white transparent membrane was thus obtained.

Steps for preparing an ion-exchange membrane in another embodiment of the present invention are as follows:

(a) The aforesaid inorganic nanoparticles with sulfonate was dissolved in 2 mL of ethanol, and mixed evenly by ultrasonic vibration. A sulfonated PEEK (sPEEK) polymeric solution (prepared by known methods in any publication) was added therein.

(b) The mixture from step (a) was stirred for 2 hours at 110° C. to volatilize the solution to increase viscosity thereof.

(c) The mixture from step (b) was coated on a glass slide, and an external electric field was applied to the slide to form a membrane thereon at 110° C. The slide was vacuumized at 110° C. to remove the residual solvent.

(d) The obtained membrane was acid-washed with 0.5 M sulfuric acid for 2 hours at 60° C. (e) The acid-washed membrane as washed by deionized water repeatedly at 60° C. until the pH value was near neutral. A yellow-brownish transparent membrane was thus obtained.

According to the example of the present invention, the external electric field applied during the preparation of a membrane had a frequency of from 0 to 150 Hz, preferably from 0 to 10 Hz.

### 4. Comparison of the Features of the Membrane

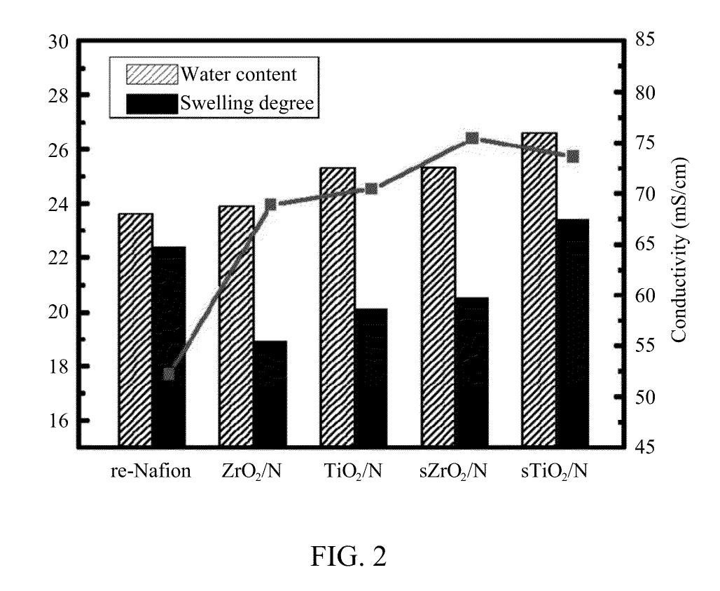

As shown in FIG. 2, the water contents, degrees of swelling and proton conductivity of the ion-exchange membrane having added nanoparticles with surface modification by sulfonation (i.e., sZrO2/N and sTiO2/N), the ion-exchange membrane having added nanoparticles without functionalization (i.e., rO2/N and TiO2/N), and self-made Nafion ion-exchange membrane (re-Nafion) of comparative example 1. A resistivity value R was calculated by Autolab/PGSTAT30 and the software, frequency response analyzer (FRA), and then R was imported to an equation σ=1/(R×A) to obtain the conductivity. Additionally, water contents and swelling degree were obtained by the equations below.

Water content=(W_{wet}−W_{dry})/W_{dry}×100%, wherein W_{wet} and W_{dry} are wet weight and dry weight of the membrane, respectively;

Swelling degree=(S_{wet}−S_{dry})/S_{dry}×100%, wherein S_{wet} and S_{dry} are wet and dry sizes of the membrane, respectively.

For the water content, sZrO₂/N ion-exchange membrane was slightly higher than ZrO₂/N ion-exchange membrane, and sTiO₂/N ion-exchange membrane was slightly higher than TiO₂/N ion-exchange membrane. The water content of the ion-exchange membrane of comparative example 1 was the lowest. For the swelling degree, the ion-exchange membrane of comparative example 1 was obviously higher than ZrO₂/N ion-exchange membrane, TiO₂/N ion-exchange membrane and sZrO₂/N ion-exchange membrane, while sTiO₂/N ion-exchange membrane was similar to the ion-exchange membrane of comparative example 1. Moreover, for the proton conductivity, the ion-exchange membrane of comparative example 1 was less than the other ion-exchange membranes having added nanoparticles with or without modifications by functional groups. Additionally, both sZrO₂/N ion-exchange membrane and sTiO₂/N ion-exchange membrane with added sulfonated nanoparticles showed higher conductivity than ZrO₂/N ion-exchange membrane and TiO₂/N ion-exchange membrane having added nanoparticles without sulfonation. Therefore, in comparison with the Nafion membrane often used in the current techniques in the art, the ion-exchange membranes with added nanoparticles can increase the water content thereof, and obviously improve the conductivity and lower the degree of swelling. The ion-exchange membrane with added sulfonated nanoparticles have more preferable water content and conductivity.

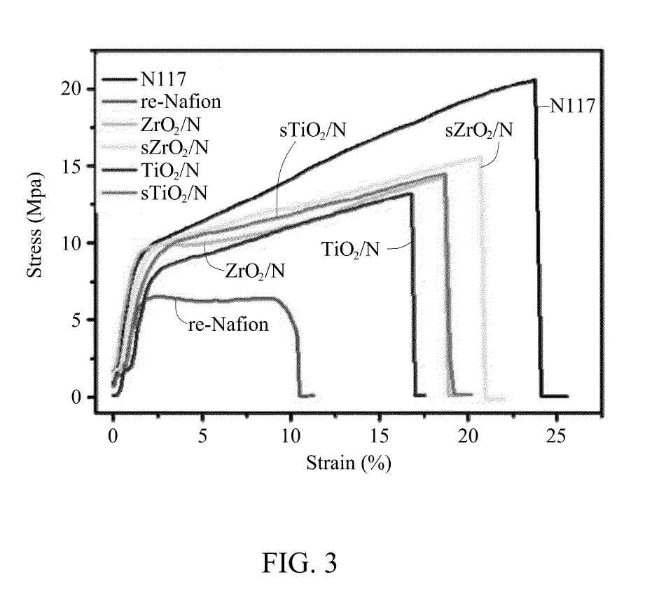

In developing ion-exchange membranes, a key challenge is to increase the proton conductivity of the membrane without losing its mechanical strength. As shown in FIG. 3 (which shows the results of an elongating test), in comparison with comparative example 1, the mechanical strengths of ZrO₂/N ion-exchange membrane and TiO₂/N ion-exchange membrane greatly increased. This is a known technique in the art that by adding inorganics to an organic composite membrane would improve the mechanical strength of the membrane. Additionally, the mechanical strength of the ion-exchange membranes with added sulfonated nanoparticles (sZrO₂/N and sTiO₂/N) were even higher than those of ZrO₂/N and TiO₂/N ion-exchange membranes. It can be inferred that compatibility of inorganic particles and polymeric substrate is increased due to the nanoparticles modified by functionalization. Thus, the results shows when nanoparticles are distribute more evenly in the polymeric substrate, a the mechanical strength of the membrane would increase.

### 5. Comparison of the Features of the Ion-Exchange Membrane with Sulfonated Nanoparticles Induced by an External Electric Field

Microphotograph of an Ion Exchange Membrane by a Scanning Electronic Microscope

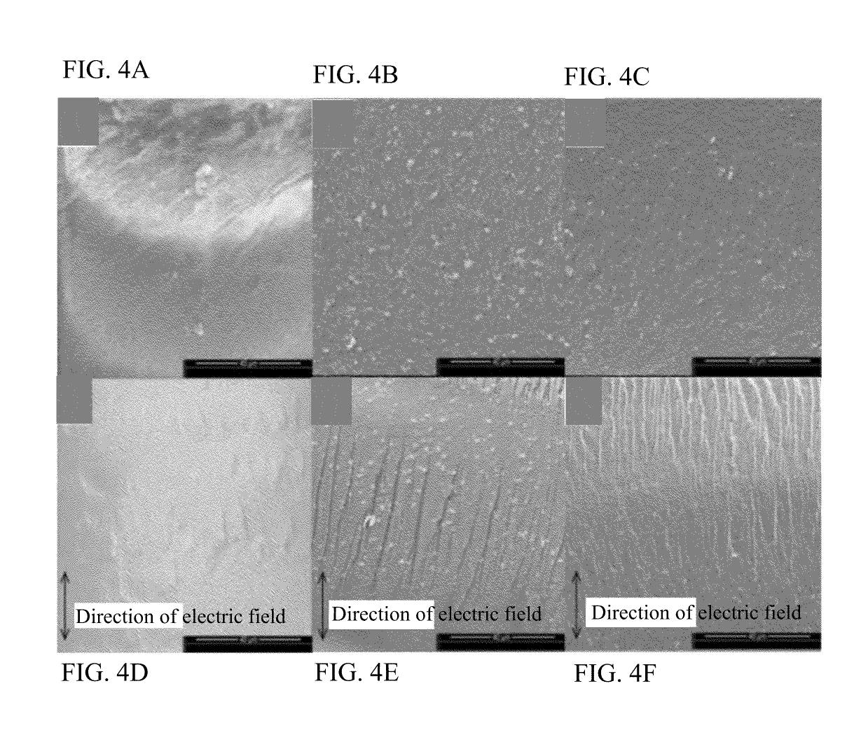

FIGS. 4A-4D show the cross-sectional images of different membranes by a scanning electronic microscope (SEM), wherein FIGS. 4A-4C indicate re-Nafion, sZrO₂/N, and sTiO₂/N ion-exchange membranes, respectively, and FIGS. 4D-4F indicate re-Nafion, sZrO₂/N, and sTiO₂/N ion-exchange membranes each prepared with an external electric field (hereinafter referred to as Nafion/DE•sZrO₂/N/DE and sTiO₂/N/DE), respectively. As shown in FIGS. 4A-4C the cross-sectional topography of the Nafion membrane with added nanoparticles was rough and irregular, and of the cross-sectional topography of the membrane with added sZrO₂/N had slight particle aggregation, and the membrane with added sTiO₂/N distributed relatively more evenly. Further, comparing the cross-sectional images of the membranes induced by an electric field, it is found that the influence by an polarization effect of an electric field, the stress curve in the direction of vertical plane of each of the cross-sectional images of the membranes is possibly caused by the continuously aggregated and ordered morphological texture of the nanoparticles induced by the electric field as shown in FIGS. 4D-4F. This provides the initial evidence that Nafion and nanoparticles form a structure with a preferentially oriented morphological texture under the influence of the electric field polarization. This also served as a key evidence that electric field induced different membrane structure and the varying morphological texture, compared to those without the electric field.

### 6. Microstructure Analysis by Small-Angle X-Ray Scattering (SAXS)

In the internal structure of polymer membrane, size, shape, and arrangement of the pores greatly affect the membrane properties. A microstructure has a size of from nanometers to hundreds of nanometers, and the nano-scaled microstructure can be observed by using small-angle x-ray (SAXS) scattering. The measured angle θ is imported to an equation: q=4π sin θ/λ, to have a q value. The scattering peak of q value at 1.725 was the ionomer peak, which was then imported to an equation d=2π/q to calculate the scale of ion agglomeration (d) or what is referred as a value of the ion cluster. As shown in Table 1, in comparison with the composite membranes of comparative example 1, sZrO₂/N and those obtained without being induced by an external electric field, the q values of Nafion/DE and sZrO₂/N/DE both increased, while the values of ion agglomeration both decreased. The values of ion agglomeration of sZrO₂/N/DE and sTiO₂/N/DE of the embodiments of the present invention were found to be less than that of the membrane of comparative example 2 (N117, the commercially available Nafion). Therefore, the ion-exchange membrane induced by an electric field of the present invention not only allows the ion agglomeration to form an oriented and ordered structure, but also decreases the scale of ion agglomeration.

TABLE 1
A comparative chart of q values of small-angle x-ray scattering
and values of the ion agglomeration of an ion-exchange membrane

| | | Value of Ion |
|---|---|---|
| Membrane | q(nm−l) | agglomeration (nm) |
| N117 | 1.725 | 3.64 |
| re-Nafion | 1.784 | 3.52 |
| Nafion/DE | 1.831 | 3.41 |
| sZrO2/N | 1.784 | 3.52 |
| sTiO2/N | HR | HR |
| sZrO2/N/DE | 1.86 | 3.38 |
| sTiO2/N/DE | 1.925 | 3.26 |

### 7. Comprehensive Comparison of the Membranes of Nafion, sZrO2/Nafion and sTiO2/Nafion Induced by an Electric Field

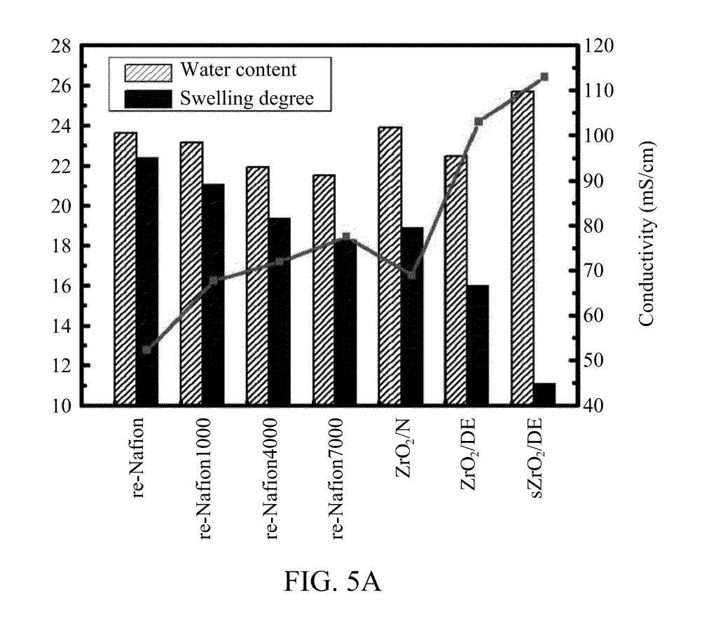

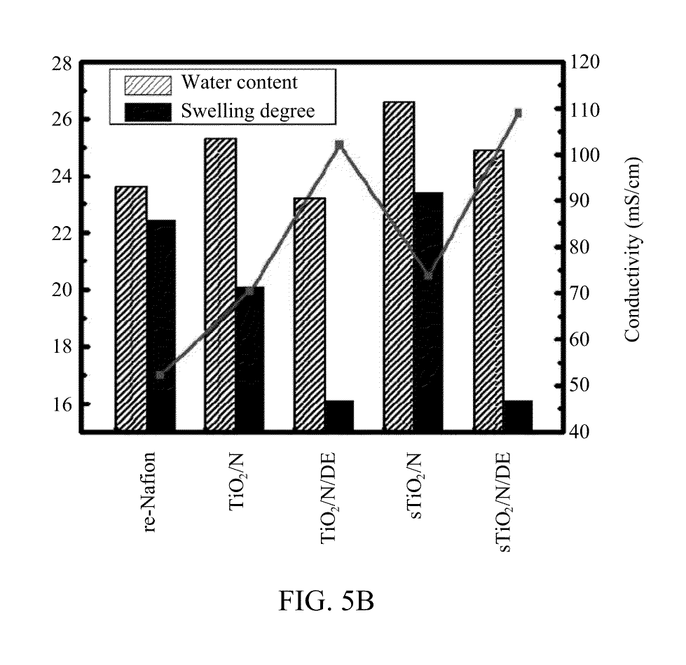

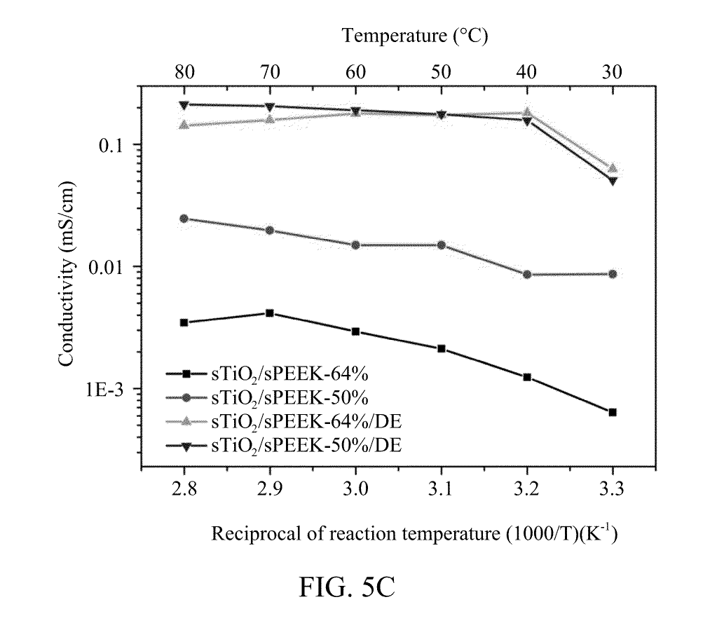

As shown in FIG. 5A, the proton conductivity of the membrane of comparative example 1 was higher as the strength of the electric field increased; meanwhile, the water absorption of the membrane decreased. For example, the conductivity of the membrane of N/DE 7000 (the strength of the electric field: 7000 V/cm) can increase to 77.5 mS/cm, water absorption can decrease to 21.5%, and the swelling degree can decrease to 18.3%. By comparison, ion-exchange membranes with added ZrO₂ nanoparticles (whether with or without modifications by functional groups) all had higher conductivity than those of comparative example 1 without being induced by an external electric field. The ion-exchange membranes with added ZrO₂ nanoparticles (whether with or without modifications by functional groups) and being induced by an external electric field (ZrO₂/N/DE and sZrO₂/N/DE), in the embodiments of the present invention, had greatly increased conductivity, while swelling degrees thereof were relatively low even when water contents were high. Also, as shown in FIG. 5B, the ion-exchange membranes with added TiO₂ nanoparticles (whether with or without modifications by functional groups) and being induced by an external electric field (TiO₂/N/DE and sTiO₂/N/DE) of the present invention had obviously higher conductivity than those obtained without external electric field, and had much lower swelling degrees when high water contents were high.

### 8. Test for the Proton Conductivity of sPEEK Membrane and the Proton Conductivity of Composite sTiO2/sPEEK Membrane Induced by an Electric Field at Varying Temperatures

As shown in FIG. 5C, at a constant relative humidity of 100%, the proton conductivity of the membranes of the present invention were measured at varying temperatures (i.e., from 30 to 80° C.), wherein sPEEK-50% and sPEEK-64% respectively indicate PEEK membranes having 50% and 64% of sulfonation. In the range of the temperatures used for the testing, the conductivity of the sTiO2/sPEEK-50% membrane obtained without being induced by an external electric field was lower, while the conductivity of the membrane of sTiO2/sPEEK-64% was even lower than the 10⁻³ S/cm level. After being induced by an electric field, the conductivity of the ion-exchange membrane of sTiO2/sPEEK-64%/DE and the conductivity of the ion-exchange membrane of sTiO2/SPEEK-50%, in the embodiment of the present invention, reached the 10⁻¹ S/cm level. Therefore, the conductivity of the ion-exchange membrane obtained after being induced by an external electric field of the present is greatly increased. In comparison with other membranes, it presents substantially higher conductivity.

### 9. Test for the Mechanical Strength of an Ion-Exchange Membrane Obtained by Inducing by an External Electric Field

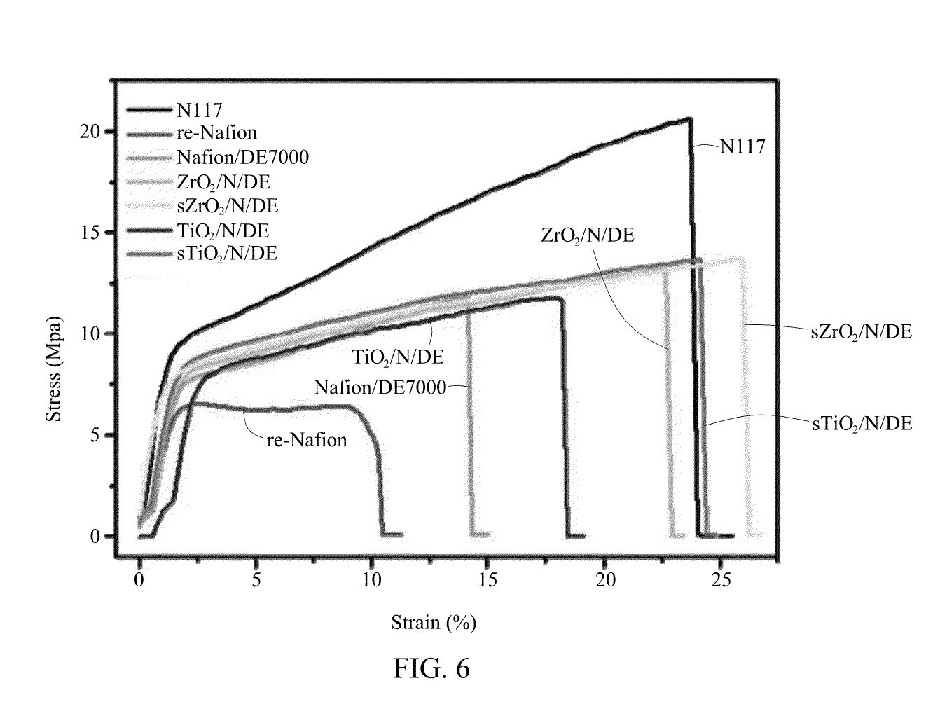

As shown in FIG. 6, in comparison with the membrane of comparative example 1, the stretching stress and strain of a Nafion/DE membrane efficiently increased about 1.5 times. Additionally, the mechanical strength of the ion-exchange membrane obtained by inducing by an electric field of the present invention can be further improved. The mechanical strength of ZrO₂/N/DE and sTiO₂/N/DE ion-exchange membranes, in the embodiment of the present invention, had preferable mechanical efficiency, and stress strength of the membranes could be up to 13 Mpa. Further, the stress of the ZrO₂/N/DE ion-exchange membrane could be up 27%, and the tolerable strain could be preferably more than that of comparative example 2.

### 10. Test for Proton Conductivity of Ion-Exchange Membranes Under Varying Humidity Conditions and Temperatures

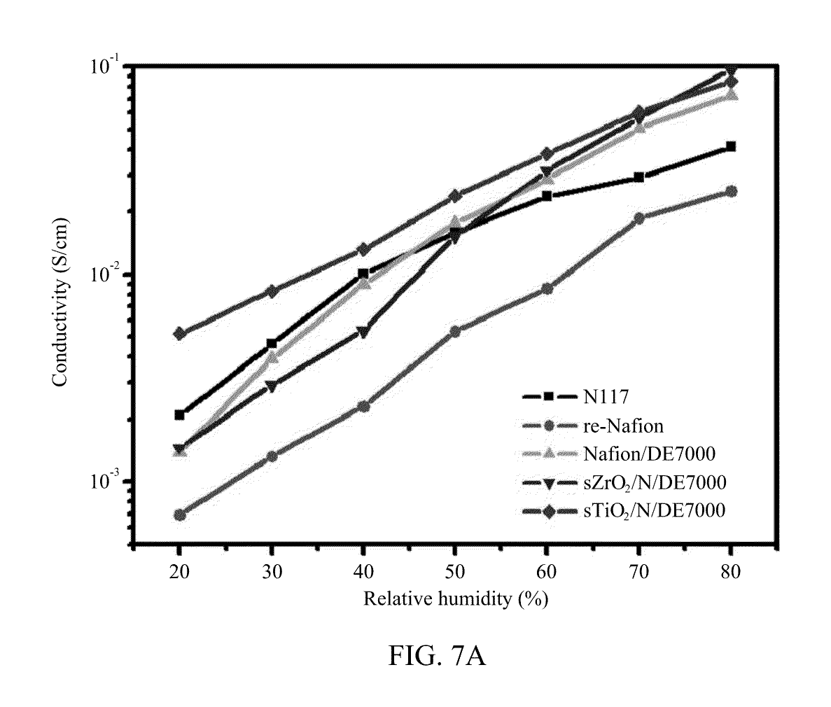

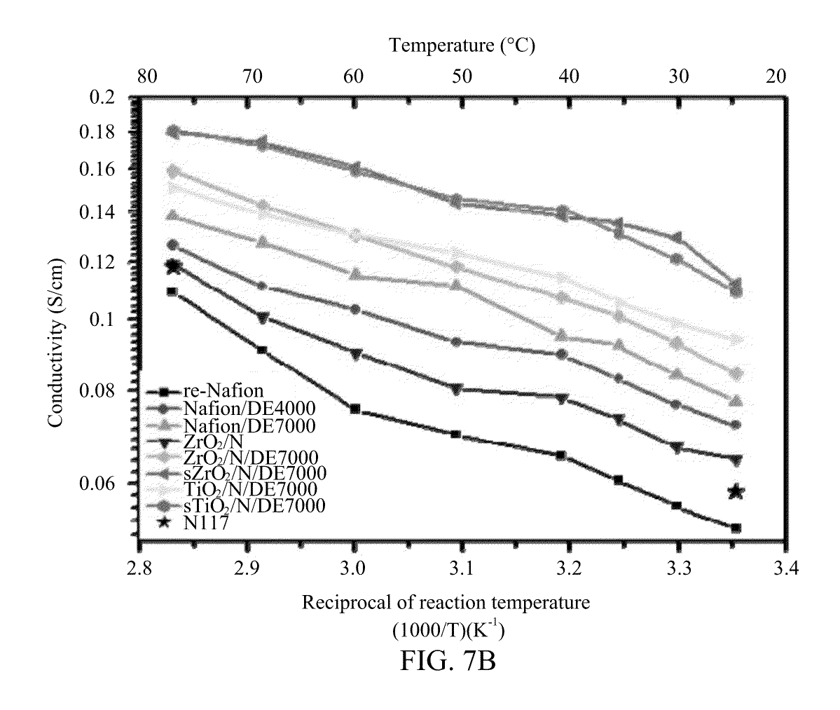

As shown in FIG. 7A, at a constant temperature of 80° C., the proton conductivity of ion-exchange membranes were measured at varying humidity conditions. The conductivity of all of the membrane conductivity decreased with decreasing humidity, wherein the sTiO₂/N/DE7000 ion-exchange membrane in the embodiment of the present invention always maintained higher proton conductivity whether at a high or low humidity. While relative humidity is more than 50%, the sZrO₂/N/DE7000 and sTiO₂/N/DE7000 ion-exchange membranes of the present invention both had higher conductivity than the membrane of comparative example 2. FIG. 7B shows the proton conductivity of the ion-exchange membranes measured in a constant relative humidity of 100% at varying temperatures. In the range of the temperatures for the testing, the sZrO₂/N/DE7000 and sTiO₂/N/DE7000 ion-exchange membranes of the present invention both had the highest conductivity in comparison with other membranes; while the ZrO₂/N/DE7000 and TiO₂/N/DE7000 ion-exchange membranes are second to them, yet are both higher than the membrane of comparative example 2.

### 11. Diffusion of Water Molecules into an Ion-Exchange Membrane

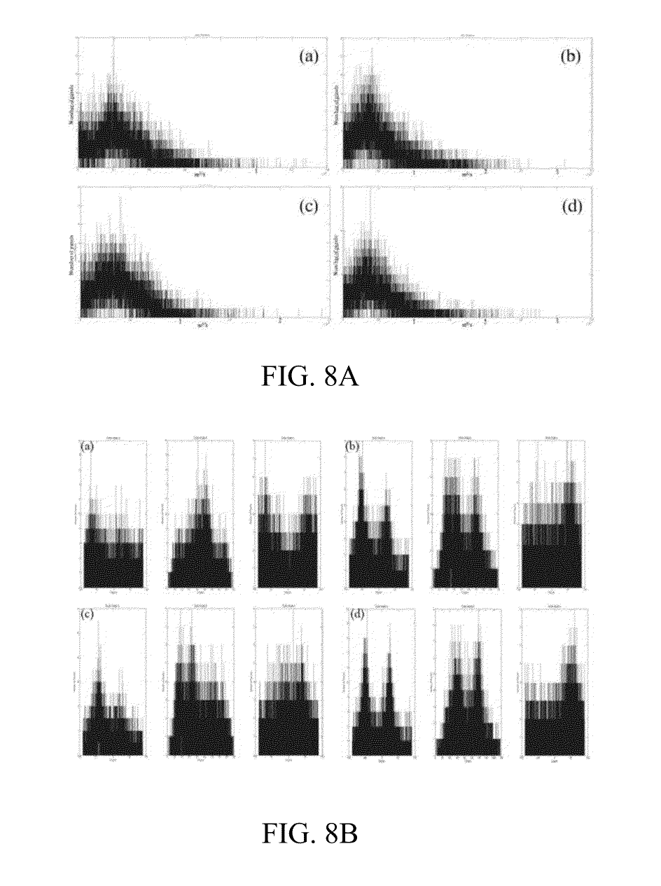

The anistropic feature of the membranes can be characterized by preferential orientation resulted from the diffusion tensor imaging (DTI) of water molecules. FIGS. 8A and 8B show the distributional diagrams of a diffusion rate and a diffusion tensor direction of the water molecules (three tensor angles positioned by Euler angles α, β, γ) as measured by DTI using solid-state nuclear magnetic resonance, wherein (a), (b), (c) and (d) are re-Nafion, Nafion/DE, sTiO₂/N and sTiO₂/N/DE membranes, respectively. As shown in FIG. 8A, an average diffusion rate of the water molecule increased along with the influences of adding sulfonated nanoparticles and induction by an electric field, wherein the sTiO₂/N/DE ion-exchange membrane of the present invention had the highest diffusion rate of water molecule. Therefore, preferential morphological texture formed in the internal structure of the membrane induced by an electric field can result in preferable efficiency performance of the membrane. As shown in FIG. 8B, the distribution of the diffusion tensor direction of the water molecules is along with the application of the electric field, wherein as the directions of the angles are more concentrated, and the directions of diffusion are more consistent. While the distribution of Euler angles α, β are narrower, the directions of the angles are more concentrated, the signal peak values are sharper, and exhibited stronger preferential orientation character. Accordingly, it explains why in the ion-exchange membrane obtained by inducing by an electric field of the present invention, the directions of diffusion of the water molecules tend to be consistent. In general, in the application of an ion-exchange membrane, the ion conductivity of the membrane is achieved by the movement of the water molecules. Therefore, the data can also explain the ion-exchange membrane obtained by inducing by an electric field as disclosed in the present invention, the proton conductivity in the membrane displayed feature of the preferential characteristic like the diffusion of the water molecules, which is found to be the strongest in the longitudinal (across-the membrane) direction.

### 12. Test for Methanol Cross-Over and Proton Conductivity of Ion-Exchange Membranes

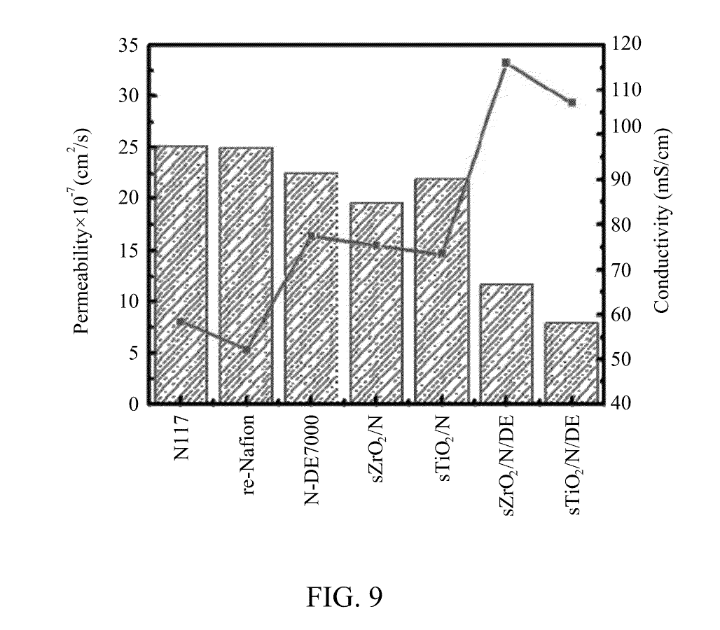

FIG. 9 shows the methanol cross-over and proton conductivity of ion-exchange membranes, wherein the sZrO₂/N ion-exchange membrane had better resistance to methanol cross-over than the sTiO₂/N ion-exchange membrane. Further, the sZrO₂N/DE and sTiO₂/N/DE ion-exchange membranes obtained by inducing by an electric field of the present invention had obviously lower methanol cross-over. Additionally, in the presence of methanol, the sZrO₂/N/DE and sTiO₂/N/DE ion-exchange membranes induced by electric field of the present invention showed superior proton conductivity, which was not only higher than that of the sZrO₂/N and sTiO₂/N ion-exchange membranes, but also higher than that of the membrane of comparative example 2. Therefore, in comparison with membranes currently used in the art, the ion-exchange membranes obtained by inducing by an electric field of the present invention have obviously higher high proton conductivity and better resistance to fuel cross-over.

### 13. Test for Single Cell Efficiency of a Direct Methanol Fuel Cell (at a Temperature of 80° C. and in a Relative Humidity of 60%)

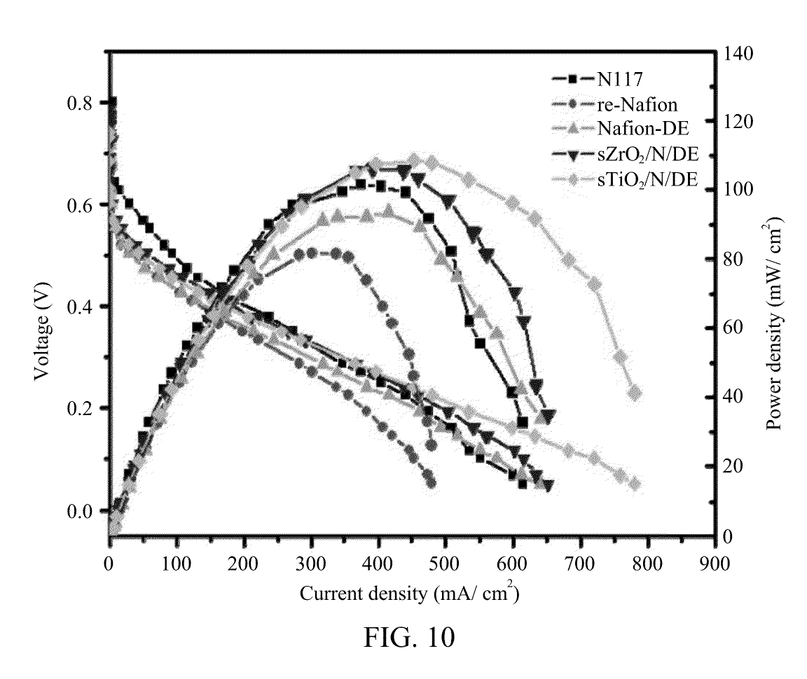

In an embodiment of the present invention, the ion-exchange membranes of the present invention were compared with the membranes of comparative example 1 and 2, in terms of single cell efficiency of a direct methanol fuel cell, wherein the methanol concentration used was 1 M, the feeding rate of an anode (Pt—Ru: 2 mg/cm²) was 20 mL/min, the feeding rate of a cathode (Pt: 2 mg/cm²) was 100 mL/min, and the balance voltage for membrane activation was fixed at 0.2 V for 12 hours at a temperature of 60° C. After activation is completed, and it was balanced at 80° C. for 1 hour before a measurement was taken. As shown in FIG. 10, in comparison with comparative examples 1 and 2, a direct methanol fuel cell using the ion-exchange membranes of the present invention showed better performance, wherein the sTiO₂/N/DE ion-exchange membrane had the highest power of up to 110 mW/cm², while the sZrO₂/N/DE ion-exchange membrane had a power of 105 mW/cm², N117 membrane had a power of 100 mW/cm², and the Nafion/DE membrane had a power of 90 mW/cm². Moreover, the current density of a cell using the sTiO₂/N/DE ion-exchange membrane of the present invention can even achieve a current density of up to 800 mA/cm². Accordingly, the ion-exchange membranes obtained by inducing by an electric field of the present invention can efficiently improve the cell efficiency.

### 14. Test for Single Cell Efficiency of a Fuel Cell Having Hydrogen and Oxygen Proton Exchange Membranes

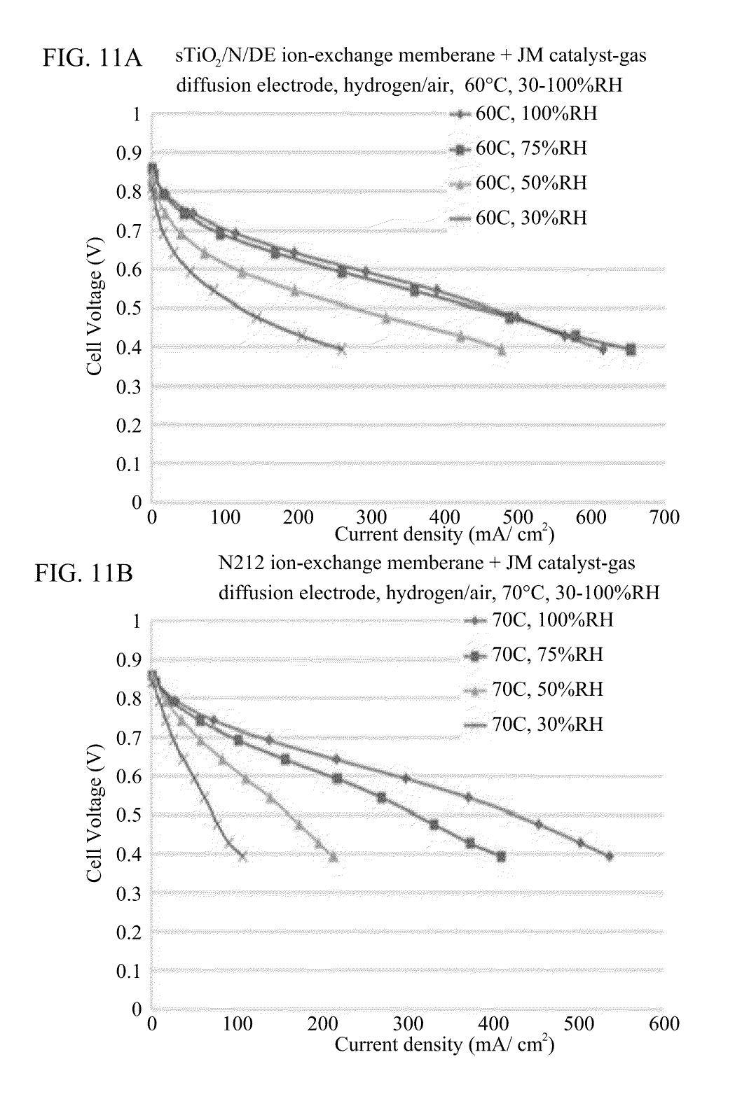

As shown in FIG. 11A and FIG. 11B, in a fuel cell with a hydrogen-oxygen proton exchange membrane, a hydrogen-oxygen fuel cell using an ion-exchange membrane (sTiO₂/N/DE) of the present invention (FIG. 11A) performs better than those using the ion-exchange membrane N212 (FIG. 11B) often used currently in the art. FIG. 11A and FIG. 11B show that, at a high relative humidity condition (>50% RH), a fuel cell using the membrane in an embodiment (sTiO₂/N/DE) of the present invention had better performance output. The electric discharge performance (i.e., current density) was less influenced by the changing in the humidity conditions, and still able to maintain at 500 mA/cm² (at voltage of 0.4 V) during even at a low humidity (<50% RH). By contrast, as shown in FIG. 11B, the output of a fuel cell made of N212 ion-exchange membrane (which is often used in the art currently) had decreased to 220 mA/cm² (at voltage of 0.4 V), which differ significantly from the fuel cells with the membranes of the present invention. A fuel cell using the ion-exchange membrane of the present invention as the proton exchange membrane has superior performance due to higher proton conductivity and the water permeability behavior, which are boosted by the preferentially oriented morphological texture resulted from formation of the membrane by the polarization of an electric field.

Consequently, in comparison with the conventionally known techniques in the art, the present invention provides an ion-exchange membrane obtained by inducing an electric field that allows inorganic nanoparticles in the membrane to distribute more evenly, and thereby forming an ordered structure. Therefore, for the ion-exchange membrane of the present invention, the mechanical efficiency and resistance to methanol cross-over are improved, the swelling degree is lowered, and both of the physical and chemical properties are good. Meanwhile, in comparison with the commercially available membranes (N117 and N 212) often used, the ion-exchange membrane of the present invention performs more better in both of the performance tests on a single direct methanol fuel cell and a fuel cell with a hydrogen and oxygen proton exchange membrane.

The above descriptions of the detailed description of the present invention are only to illustrate the principles and advantages of the present invention, and they are not intended to limit the scope of the present invention. Nonetheless, it is possible for a one skilled in the art to make various modifications and changes to the embodiments supra in accordance with the spirit and scope of the present invention defined by the appended claims.

What is claimed:

1. An ion-exchange membrane with a preferentially oriented morphological texture, comprising:
a polymeric substrate; and
a plurality of nanoparticles embedded in the polymeric substrate, wherein the amount of the nanoparticles is from 0.1 to 5 wt %, based on a total weight of the ion-exchange membrane, and a value of ion agglomeration is less than 3.4 nm.

2. The ion-exchange membrane of claim 1, wherein the amount of the polymeric substrate is from 99.9 to 95 wt %.

3. The ion-exchange membrane of claim 1, wherein the nanoparticles are inorganic nanoparticles.

4. The ion-exchange membrane of claim 3, wherein the inorganic nanoparticles are at least one inorganic nanoparticles selected from the group consisting of titanium dioxide (TiO₂), silicon dioxide (SiO₂), aluminum oxide (Al₂O₃), zirconium dioxide (ZrO₂), and a carbon nanotube.

5. The ion-exchange membrane of claim 1, wherein each of the nanoparticles are modified by sulfonate (SO₃⁻), phosphite (PO₃²⁻), or carboxylate (COO⁻).

6. The ion-exchange membrane of claim 1, wherein each of the nanoparticles are cylindrical, and have a length-to-diameter ratio of more than 1.

7. The ion-exchange membrane of claim 6, wherein each of the nanoparticles has a length-to-diameter ratio of about 2 to 100.

8. The ion-exchange membrane of claim 1, wherein the polymeric substrate is at least one selected from the group consisting of polyether ether ketone (PEEK), a perfluorinated sulfonic acid resin (Nafion), poly(imide) (PI), polysulfone, poly(vinylphosphonic acid) (PVPA), and poly(acrylic acid) (PAA).

9. The ion-exchange membrane of claim 1, wherein the polymeric substrate is modified by sulfonate (SO₃⁻), phosphite (PO₃²⁻), or carboxylate (COO⁻).

10. The ion exchange membrane of claim 1, wherein the value of ion agglomeration is from 3.2 to less than 3.4 nm.
